(19) United States
(12) Patent Application Publication
(10) Pub. No.: US 2002/0108116 A1
(43) Pub. Date: Aug. 8, 2002

(54) Satellite broadcasting system employing channel switching

(76) Inventor: Douglas M. Dillon, Gaithersburg, MD (US)

Correspondence Address: FITZPATRICK CELLA HARPER & SCINTO, 30 ROCKEFELLER PLAZA, NEW YORK, NY, 10112, US

(21) Appl. No.: 10/077,339

(22) Filed: Feb. 15, 2002

Related U.S. Application Data
(63) Continuation of application No. 08/838,242, filed on Apr. 16, 1997.

(51) Int. Cl. H04N 7/20

(52) U.S. Cl. 725/63; 725/68

(57) ABSTRACT

A satellite broadcasting system includes a multi-channel transmitter and a multi-channel receiver. The transmitter transmits data signals on first and second communication channels via satellite, and the receiver receives the data signals on the first and second communication channels. The receiver includes a tuner responsive to a selected communication channel indication for tuning in a particular one of the first and second communication channels identified by the selected communication channel indication. The transmitter transmits to the receiver on the particular communication channel based on the selected communication channel indication.

### BACKGROUND OF THE INVENTION

(a) Field of the Invention

The present invention relates generally to a system and a method for broadcasting data signals via satellite and, more particularly, to a system and a method for efficiently distributing satellite-broadcast data transmissions dynamically among a plurality of communication channels to enhance broadcast efficiency.

(b) Background of the Invention

Conventional satellite broadcasting systems employ a satellite transmitting station to transmit one or more data uplink signals to one or more satellites, each occupying a respective geosynchronous orbital slot above the Earth. The satellites receive the uplink signals, amplify them, and rebroadcast them back to Earth as downlink signals at different frequencies. Specifically, the downlink signals are received at all points on Earth within a satellite “footprint” associated with the satellite.

The footprint of a satellite refers both to the geographical area on the surface of the Earth within which downlink signals from the satellite can be received and also, more particularly, to a downlink signal profile which comprises a measure the power or intensity of the downlink signal at each point in that geographical area. In other words, a receiver located within the satellite footprint and having an antenna pointed at the satellite is able to receive the downlink signal from the satellite. However, the power level of the downlink signal as received by any particular receiver depends on the location of the satellite in relation to the location of the receiver and also on the shape of the satellite receiving antenna associated with the receiver. To compensate at least partially for this variation in downling signal power, a satellite footprint customarily is partitioned into areas, and the satellite downlink signal is broadcast to each area with a predetermined power level. A receiving station may then receive the satellite downlink signal at the predetermined broadcast power level, or the downlink signal power may be attenuated in power such that the receiving station receives a weaker downlink signal than that broadcast by the satellite. Significantly, satellite signal receiving equipment may vary in sensitivity to satellite broadcast signals. Thus, “better” (i.e., more sensitive) satellite receivers generally can receive weaker downlink signals that often cannot be received by less sensitive receivers.

Numerous factors can impair the reception of a satellite downlink signal or attenuate the power level thereof at various locations within the satellite footprint. For example, rain fade and other forms of climatic interference can attenuate the signal as it passes through the atmosphere between the satellite and a receiver at a particular location in the satellite footprint. In addition, the downlink signal received by receivers located in some portions of the satellite footprint (for example, at the perimeter thereof) may inherently be is less powerful than the downlink signal received by receiving stations located in other portions of the satellite footprint (for example, at more central locations). Still further, a receiving station may not receive the downlink signal at full power if the satellite receiving antenna is not pointed directly at the satellite and may, in fact, receive interfering signals from one or more other satellites positioned in geosynchronous orbital slots adjacent to the slot in which the principle satellite is positioned. Such interference may also be encountered by receivers employing unduly small satellite receiving antennas which may be too small to be focused on only a single satellite.

The downlink signal broadcast by a commercial satellite broadcast service must be received by each subscriber of the service a substantial portion of the time (e.g., 99.7%). This requirement, called broadcast signal “availability” has effectively limited the data transmission rate or bit rate employed by prior satellite broadcast services. For obvious commercial and performance-related reasons, a broadcasting system should employ as high a bit rate as is practicable. However, the bit rate employed for the downlink signal of a satellite broadcast system must be low enough to ensure not only that the downlink signal is strong enough to be received at an acceptable power level in all portions of the satellite footprint (i.e., that a sufficient “availability” is attained), but also that a marginal amount of additional signal power is available to compensate for signal attenuation due to the various factors described above.

To realize a commercially acceptable signal availability level, prior satellite broadcasting systems have employed a transmission bit rate low enough that even a receiver in the region of the satellite footprint where downlink signal attenuation is greatest can receive the downlink signal at a usable power level and even in “worst-case” weather conditions. In fact, such systems often use an even lower bit rate to provide a reasonable degree of additional signal power margin to compensate for extraordinary attenuation some percentage of the time. This practice, once again, serves to enhance downlink signal availability. By using such a low bit rate, however, such systems leave excess transmission capacity unused in those portions of the satellite footprint where downlink signal attenuation is less extreme.

### SUMMARY OF THE INVENTION

The present invention enables a satellite broadcasting system to broadcast on multiple communication channels and at multiple bit rates to maintain a high availability rate while increasing the bit rate of transmissions to receivers in low-attenuation areas of a satellite footprint.

According to one aspect of the invention, a satellite broadcasting system comprises a transmitter including transmitting means for transmitting data signals on first and second communication channels via satellite and a receiver including receiving means for receiving the data signals on the first and second communication channels. The receiver also includes tuning means responsive to a selected communication channel indication for tuning in a particular one of the first and second communication channels identified by the selected communication channel indication. The transmitter transmits to the receiver on the particular communication channel based on the selected communication channel indication.

In one embodiment, the receiver further includes selecting means coupled with the receiving means for selecting one of the first and second communication channels and developing a selected communication channel indication and communicating means for communicating the selected communication channel indication to the transmitter. Each communication channel has a load level, and a communication channel is selected by the selecting means according to which communication channel has the lowest load level. In this embodiment, the communicating means provides the transmitter with a selected communication channel indication via a dial-in connection to the transmitter. Preferably, the transmitter is responsive to the indication and thereby transmits to the receiver on the selected communication channel.

Also in this embodiment, the first communication channel has a first bit rate and the second communication channel has a second, greater bit rate. Further, signals received by the receiver are characterized at any given time by an energy-per-bit to noise ratio, and the receiver further includes means for monitoring the energy-per-bit to noise ratio. If, at any time, the receiver is tuned to the second communication channel, the selecting means selects the first one if the energy-per-bit to noise ratio of the receiver falls below a predetermined shift-low threshold. Moreover, each communication channel has a load factor, and if the receiver is tuned to the first communication channel, the selecting means selects the second one if the energy-per-bit to noise ratio of the receiver rises above a predetermined shift-high threshold and the load factor of the second communication channel is less than that of the first.

In an alternative embodiment, the transmitter includes selecting means coupled with the transmitting means for selecting one of the first and second communication channels for communication with the receiver and notifying means responsive to the selecting means for providing the receiver with a selected communication channel indication. Here, too, a communication channel is selected by the selecting means according to which communication channel has the lowest load level. The notifying means provides the receiver with an indication of the selected communication channel via the particular communication channel to which the receiver is already tuned. The tuning means of the receiver is responsive to that indication and thereby tunes in to the selected communication channel.

As in the embodiment described above, the first and second communication channels have respective first and second bit rates, the second bit rate greater than the first. Signals received by the receiver are characterized at any given time by an energy-per-bit to noise ratio, and the receiver includes means for monitoring the energy-per-bit to noise ratio. Periodically, the receiver communicates the energy-per-bit to noise ratio of the received signal to the transmitter. If, at any time, the receiver is tuned to the second communication channel, the selecting means selects the first one if the energy-per-bit to noise ratio of the receiver falls below a predetermined shift- low threshold. Likewise, if the receiver is tuned to the first communication channel, the selecting means selects the second communication channel if the energy-per-bit to noise ratio of the receiver rises above a predetermined shift-high threshold and the second communication channel has a load factor lower than that of the first communication channel.

According to another aspect of the invention, the transmitter transmits digital data signals at a first bit rate on the first communication channel and transmits digital data signals at a second bit rate different from the first bit rate, and optionally greater than the first bit rate, on the second communication channel. Alternatively, the transmitter may transmit digital data signals at equal bit rates on the first and second communication channels. Furthermore, the first and second communication channels may comprise signals broadcast by a single satellite transponder at different frequencies. Alternatively, the first and second communication channels may comprise respective first and second signals broadcast by at least one satellite at a single frequency, wherein one of the first and second signals has a different polarization than the other. For example, one of the first and second signals may be left-hand circularly polarized while the other signal is right-hand circularly polarized.

According to another aspect, the first and second communication channels may comprise signals broadcast by a plurality of satellite transponders or only one, and such signals may be broadcast by a single satellite or by a plurality of satellites.

The transmitter preferably transmits to the receiver on one of a plurality of communication channels, said plurality including the first and second communication channels, and preferably includes means for determining a communication channel load factor for each of the plurality of communication channels.

The transmitter may transmit to the receiver on a particular one of the communication channels based on the communication channel load factors, or the transmitter may transmit to the receiver on a channel selected in an effort to substantially uniformly allocate communication among the communication channels.

According to another aspect of the invention, the first communication channel may comprise a first digital signal having a first bit rate and a first load level and the second communication channel may comprise a second digital signal having a second bit rate greater than the first bit rate and a second load level. In one embodiment, the load factor of the first communication channel is elevated so as to exceed the first communication channel load level (e.g., by about twenty five per cent), and the load factor of the second communication channel substantially equals (i.e., accurately reflects) the second communication channel load level.

According to yet another aspect of the invention, the transmitter broadcasts information pertaining to each communication channel. For example, each communication channel may be characterized by a frequency, a bit rate, a power level, and a load factor, and the information broadcasted by the transmitter pertaining to each communication channel may comprise the communication channel's frequency, bit rate, power level and/or load factor.

### BRIEF DESCRIPTION OF THE DRAWINGS

FIG. 1 is a diagrammatic of a satellite downlink signal footprint partitioned into a plurality of regions, each having a corresponding satellite downlink signal power level;

FIG. 2 is a diagrammatic view of a satellite broadcasting system according to the present invention; and

FIG. 3 is a block diagram of the transmitter and the receiver of FIG. 2.

### DESCRIPTION OF THE PREFERRED EMBODIMENTS

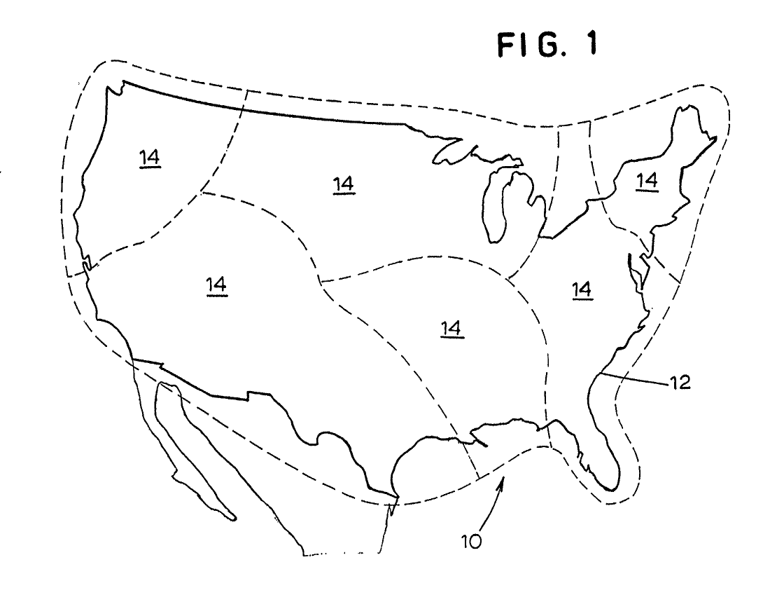

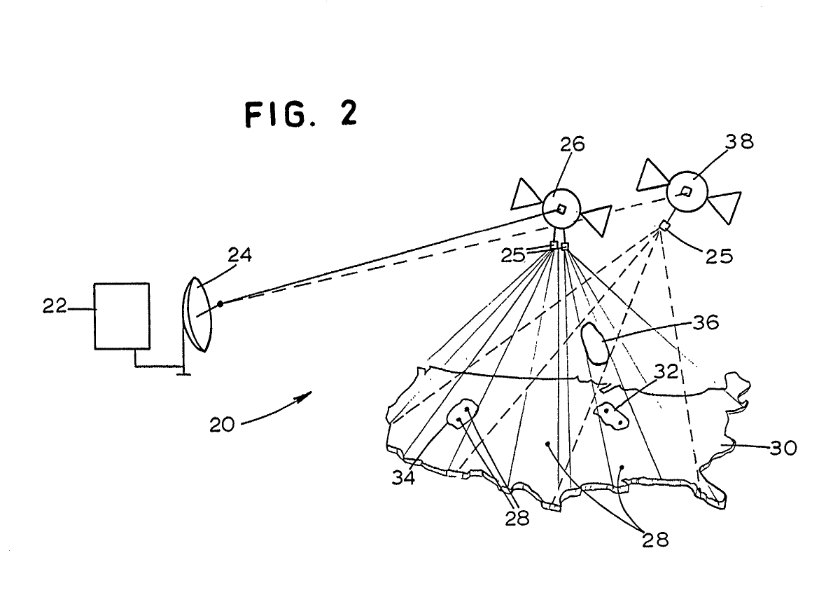

FIG. 1 depicts a satellite downlink signal footprint 10. Employing a satellite broadcasting system 20 (FIG. 2) in accordance with the present invention, satellite broadcasting service may transmit data signals via satellite throughout an area on the surface of the Earth. For example, such a system may broadcast signals over the entire continental United States (CONUS) 12. The footprint 10 is-shown to be divided into a plurality of regions 14. Each such region corresponds to an area where the satellite broadcasts the downlink signal thereof at a particular power level. The power level of the downlink signal as broadcast to each of the various regions 14 of the footprint 10 generally varies from one region to another in order to at least partially compensate for region-dependent downlink signal attenuation due to the various causes described above.

As shown in FIG. 2, a satellite broadcasting system 20 employs a satellite transmitter or transmitting station 22 having a satellite transmitting antenna 24 or other transmitting means for transmitting data signals via at least one geosynchronous satellite 26 to a plurality of receivers 28 located within a downlink signal footprint 30 of the satellite 26. The receivers 28 receive a downlink signal from the satellite 26.

Illustrated in FIG. 2 are exemplary regions 32 and 34 of the footprint 30 where the downlink signal may be attenuated to various degrees and for various reasons. For example, the downlink signal from the satellite 26 may be quite attenuated in the region 32 due to climatic interference represented pictorially in FIG. 2 by a cloud 36. On the other hand, the downlink signal may reach the region 34 of the footprint 30 (where less or no climatic interference is present) without appreciable attenuation. Also, receivers 28 in the regions 32 and 34 and those in other portions of the footprint 30 may encounter varying degrees of interference from one or more other satellites (e.g., satellite 38) occupying geosynchronous orbital slots adjacent to that occupied by the satellite 26.

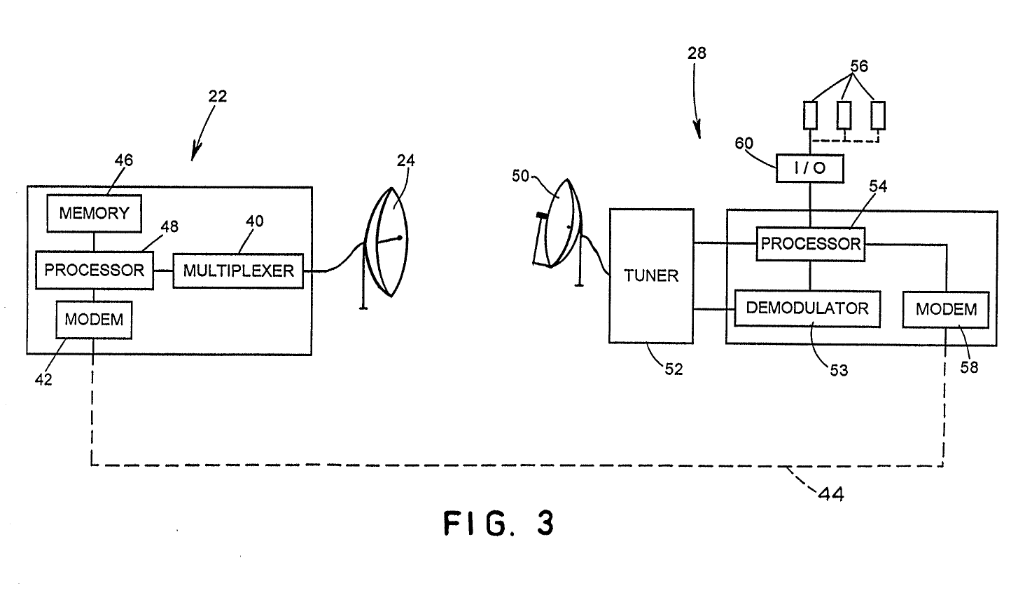

The transmitter 22 and an exemplary receiver 28 are illustrated in greater detail in FIG. 3. As illustrated therein, the transmitter 22 comprises a satellite broadcasting antenna 24 and a data multiplexer 40 or other suitable means for allocating data to one of a plurality of communication channels, such as through the use of time-division and/or frequency-division multiplexing of the data into various time and/or frequency slots in an uplink signal transmitted to the satellite 26 by the transmitting antenna 24. Of course, any desired multiplexing scheme (including, but not limited to, statistical and time-division multiplexing of data packets) can be used.

As will be readily apparent to those of ordinary skill in the art, the communication channels may comprise different frequency bands broadcast by one or more transponders 25 (FIG. 2), whether of the single satellite 26, or of multiple satellites (e.g., 26 and 38). Alternatively, the communication channels may comprise signals broadcast in the same frequency band with different polarizations. For example, left-hand circular polarized (LHCP) and right-hand circular polarized (RHCP) signals may be used for first and second communication channels.

The transmitter 22 also includes one or more modems 42 or other means by which the receivers 28 may communicate with the transmitter 22, such as over telephone lines 44, for example, or alternatively via a packet network such as the Internet (not shown), or via a satellite return communication channel (not shown). In addition, the transmitter 22 includes a memory 46 for storing data for subsequent transmission and a processor 48 coupled with the memory 46, the modem 42, and the multiplexer 40 and suitably programmed for controlling the various functions of the transmitter 22.

In addition, as will also be recognized by those of ordinary skill in the art, the processor 48 of the transmitter 22 may be programmed to determine a communication channel load factor (representing the communication load level present on a communication channel at any given time) for each communication channel on which the transmitter 22 transmits. Such programming, or any other suitable means for determining communication channel load factors, permits the transmitter 22 to transmit to the receiver 28 on a particular one of the communication channels based on the communication channel load factors. In other words, at any given time, the transmitter 22 (or, in other embodiments described below, the receiver 28) can select the communication channel carrying the lowest load of communication traffic by simply examining the communication channel load factors. Alternatively, the transmitter 22 may seek to select communication channels for particular receivers 28 (or, as also described below, a receiver 28 may select a communication channel) in an effort to substantially uniformly allocate communication among the various available communication channels.

As also shown in FIG. 3, each receiver 28 within the footprint 30 of the satellite 26 includes a satellite receiving antenna 50 or other suitable means for receiving data signals on first and second communication channels (which are among those on which data signals are transmitted by the transmitter 22). The receiver 28 also comprises a is tuner 52 for tuning in to a particular one of the communication channels, a digital demodulator 53, a processor 54 for controlling the tuner 52 and the demodulator 53, and one or more input and/or output devices 56, including a modem 58, which are coupled with the processor 54 through an input/output (I/O) block 60. An exemplary receiver 28 is a personal computer equipped with a DirecPC™ satellite broadcast receiving system manufactured by Hughes Network Systems, Inc., a unit of Hughes Electronics Corporation, to which the present application is assigned.

The particular communication channel selected for communication with a particular receiver 28 within the satellite footprint 30 may be identified by a selected communication channel indication. Whenever a new communication channel is selected for use by the transmitter 22 in transmitting data to the particular receiver 28, the transmitter 22 thereafter transmits to the particular receiver 28 on that communication channel based on the selected communication channel indication.

As noted above, either the transmitter 22 or the receiver 28 may include means for selecting a particular communication channel to be used for communication from the transmitter 22 to the receiver 28. In one embodiment, the processor 54 of the receiver 28 is coupled with the receiving means 50 thereof, and the receiver 28 selects the particular channel to be used. The receiver 28 then communicates an indication of the selected channel to the transmitter 22 via a suitable communicating means such as a modem 54 for establishing the dial-in connection 44 between the receiver 28 and the transmitter 22. Upon receiving such a selected communication channel indication from the receiver 28, the transmitter 22 begins transmitting to the receiver 28 on the communication channel specified by the selected communication channel indication. When a receiver 28 is turned on, the receiver 28 selects and tunes to the communication channel having the smallest load factor, as broadcast by the transmitter 22 as described herein. The receiver 28 then communicates to the transmitter 22 a selected communication channel indication specifying that the receiver 28 has tuned to the selected communication channel via the dial-in connection 44. Thereafter, the transmitter 22 transmits to the receiver 28 on the selected communication channel until it receives another selected communication channel indication from the receiver 28.

Rather than being selected by the receiver 28 itself, the communication channel used to communicate with a particular receiver 28 may alternatively be selected by the transmitter 22. In such an embodiment, the transmitter 22 includes the means for selecting a particular communication channel for communication with a particular receiver 28. Also in such an embodiment, the transmitter 22 must be periodically provided with an identification of the communication channel on which the particular receiver 28 is receiving, and a current measurement of the quality or power level of the received signal. In addition, the transmitter includes means responsive to the selecting means for providing the receiver with a selected communication channel indication. For example, the transmitter 22 may transmit the selected communication channel indication on the channel to which the particular receiver 28 is already tuned, or on all communication channels. Thereafter, upon receiving such a selected communication channel indication, the receiver 28 tunes in to the new communication channel specified thereby.

Each communication channel has a load level corresponding to the amount of communication traffic present on the communication channel at any given time. In general, whether channel selection is performed by the transmitter 22 or by the receiver 28, the communication channel used for communication with any particular receiver 28 is selected according to which communication channel has the lowest load level. In that way, the satellite broadcasting system 20 effectively allocates communication substantially uniformly among the various available communication channels. Of course, communication channels may be allocated in any desired way. One other example would be to first deplete all available high-speed (or low-power) communication channels and to keep lower speed (and/or higher power) communication channels in reserve for use in transmitting to receivers 28 encountering severe downlink signal attenuation.

Although the communication channels can comprise digital signals at a single, common bit rate, the satellite broadcasting system 10 of the present invention is particularly beneficial when the communication channels comprise digital signals having differing bit rates. In particular, the transmitter 22 may broadcast to a particular receiver 28 either on a first communication channel having a first bit rate (e.g., 11.79 Megabits per second) or on a second communication channel having a second bit rate greater than the first bit rate (e.g., 23.58 Megabits per second).

Signals received by the receiver 28 are inherently characterized, at any given time, by an energy-per-bit to noise ratio (Eb/No), which provides some indication of the strength or quality of the signal being received. Each receiver 28 should therefore include means for periodically monitoring the Eb/No of the received signal. For example, the processor 54 of a receiver 28 may analyze the signal received by the antenna 50 to determine the Eb/No thereof.

The Eb/No of the signal received by a receiver 28 provides some indication of whether that signal is strong enough to be reliably used by the receiver 28. Moreover, if the Eb/No is sufficiently high, then the receiver 28 will be able to receive the signal even if the bit rate of the transmission is increased. Therefore, if the receiver 28 is tuned to the first communication channel, the selecting means selects the second communication channel if, at any time, the Eb/No of the receiver 28 rises above a predetermined “shift-high” threshold, and provided that the second communication channel has a load factor lower than that of the first communication channel. The shift-high threshold may be about 4.5 dB higher than the “operating point” of the demodulator 53 of the receiver 28 (i.e., the lowest signal-to-noise ratio at which the demodulator 53 converts the received signal into a digital bitstream with an acceptable bit-error rate). Similarly, if the Eb/No falls below a predetermined “shift-low” threshold while the receiver 28 is tuned to the second communication channel, the selecting means selects the first, lower bit-rate communication channel. The shift-low threshold may be about 0.5 dB higher than the operating point of the demodulator 53 of the receiver 28.

Of course, if the communication channel selection is performed by the transmitter 22 as described above, then the receiver 28 must periodically communicate the Eb/No (and perhaps an indication of the communication channel to which the receiver is tuned) to the transmitter 22 via the communicating means 58 so that the selecting means 40 of the transmitter 22 can properly determine which communication channel (e.g., which bit rate or which power level) should be used. It should be noted that any other suitable measure of signal strength equivalent to, or similar to, the Eb/No can be used in place of the Eb/No in determining whether an when to change the communication channel used for a particular receiver 28.

As noted above, the load levels of the various communication channels of the transmitter 22 are represented by numerical load factors. Where communication channels of different bit rates are employed by the transmitter 22, the load factors of low-speed channels can beneficially be biased upward so that they exceed the actual load levels of the respective low-speed communication channels. For example, the load factor of a particular communication channel might be incremented by about twenty-five per cent above the actual load level of that communication channel. In that way, in the selection of a communication channel for a particular receiver 28, whether performed by the receiver 28 itself or by the transmitter 22, higher-speed communication channels will tend to be favored over lower communication channels.

To facilitate selection of a suitable communication channel by the receiver 28, the transmitter 22 broadcasts, on each communication channel, information about each available communication channel. For example, this information may include the frequency, bit rate, transmission power level and/or load level (or load factor) of each communication channel. The processor 54 of each receiver 28 must therefore be programmed to receive and process this information in the course of determining whether and when to tune in to a different communication channel.

As explained in detail below, the following table illustrates the increase in performance of a satellite broadcasting system 10 made possible by the use of the present invention. In particular, the table compares the data transmission rates of systems employing communication channels having one and two bit rates.

| NUMBER OF | | NUMBER OF | | | |
|---|---|---|---|---|---|
| CHANNELS IN | | CHANNELS IN | | | |
| SINGLE-RATE | | DUAL-RATE | | | |
| SYSTEM | DATA | SYSTEM | | DATA | |
| 11.79 | RATE | 11.79 | 23.58 | RATE | DATA |
| Mbits/Sec | (Mbits/ | Mbits/Sec | Mbits/Sec | (Mbits/ | RATE |
| (LR) | Sec) | (LR) | (HR) | Sec) | GAIN |
| 1 | 11.79 | 1 | 0 | 11.79 | 1 |
| 2 | 23.58 | 1 | 1 | 35.37 | 1.5 |
| 3 | 35.37 | 1 | 2 | 58.95 | 1.667 |
| 4 | 47.16 | 1 | 3 | 82.53 | 1.75 |
| 5 | 58.95 | 1 | 4 | 106.11 | 1.8 |

The left-most segment of this table shows the data transmission rate, expressed in megabits per second (Mbits/sec), of a satellite broadcasting system having only one transmission bit rate. In this case, the data rate is simply the product of the number of communication channels and the transmission bit rate of each. In the system of this example, all communication channels have a bit rate of 11.79 Mbits/sec to ensure that the system realizes an acceptable level of availability as described above. Hence, as is shown in the foregoing table, a system having five 11.79 Mbit/sec communication channels will have a data rate of 58.95 Mbits/sec (5×11.79 Mbits/sec). In general, a system having n communication channels, each having a bit rate LR that is low enough to provide adequate signal availability in worst—case conditions, will have a data rate of n×LR Mbits/sec.

The middle segment of the table shows the data transmission rate of a satellite broadcasting system 10 having two different transmission rates in accordance with the present invention. In the example given in the table, one communication channel remains at the low bit rate of 11.79 Mbits/sec for use by receivers 28 located in portions of the satellite footprint 30 where the downlink signal is substantially attenuated. Any additional communication channels operate at a higher bit rate (e.g., 23.58 Mbits/sec) for use by the majority of receivers operating with better-than-worst-case downlink signal attenuation. Obviously, the data rate of the system increases with the number of communication channels of either speed, but the foregoing table also illustrates the increase in system data rate made possible by increasing the bit rate of communication channels used for transmission to receivers 28 that are not burdened by significant downlink signal attenuation. In the general case, a dual-rate system 10 having the same number (n) of communication channels, m of which operate at a low bit rate LR (e.g., 11.79 Mbits/sec) and n-m of which operate at a high bit rate HR (23.58 Mbits/sec), has a data rate of m*LR+n*HR Mbits/sec.

The right-most segment of the table shows the data-rate gain realized by operating some of the n communication channels at the high bit rate HR, compared with operating all n communication channels at the low bit rate LR. The data-rate gain is simply the ratio of the data transmission rate of a dual-rate system to the data rate of a single-rate system having an equal number of communication channels. Once again, the gain increases with the number of communication channels. In general, the data rate gain is expressed as

$$\frac{m * LR + ( n - m ) * HR}{n * LR}$$

Mbits/sec for a dual-rate system compared with a single rate system.

In view of the foregoing disclosure, it will be apparent to those skilled in the art that even further increases in the data rate of a satellite broadcasting system can be realized by providing additional communication channels at progressively higher data rates. Of course, correspondingly graduated threshold Eb/No levels will be used to trigger the selection of a higher- or lower-rate communication channel by either the transmitter 22 or a receiver 28, but the modifications that would need to be made to the system 10 described above to implement multiple bit rates are well within the capabilities of a skilled artisan.

Further, it should be noted that the present invention is not limited to any particular manner of implementing communication channels having different bit rates. As explained above, the low bit rate described herein (i.e., 11.79 Mbits/sec) is chosen to realize adequate availability based on an is assessment of worst-case conditions over the satellite footprint 30 covering the continental United States. This data rate is obtained using binary phase shift key (BPSK) modulation to develop the satellite downlink signals. The high bit rate of 23.58 Mbits/sec is simply twice the low bit rate and is obtained by modulating data using quaternary phase shift key (QPSK) modulation, rather than BPSK which inherently requires transmission at half the bit rate of QPSK.

Still further, it should be noted that the benefit of the present invention can be obtained not only by employing communication channels having different transmission bit rates, but also by employing communication channels having equal transmission bit rates but different signal power levels. More particularly, a transmitter can transmit to a receiver on a low-power communication channel under “blue-sky” conditions (or by default), and transmission can be moved to a relatively higher-power communication channel when the signal is not being received with adequate power (e.g., when the Eb/No of the signal falls below a predetermined threshold).

As those skilled in the art will readily recognize, the operating cost of a low-power (or low-bit-rate) communication channel are lower than the operating cost of a high-power (or high-bit-rate) communication channel. Thus, substantial cost savings can be realized either by increasing the overall bit transmission rate of a system without correspondingly increasing the power consumed by the system for the transmission or, alternatively, by decreasing the power consumed by the system without correspondingly decreasing the bit transmission rate.

Significantly, the processor 48 of the transmitter 22 may compile any necessary or desirable statistics relating to the usage of the various available communication channels and their corresponding bit rates so that communication channels can occasionally be reallocated to different bit rates to increase system performance even further.

While the present invention has been described herein with reference to specific examples, those examples are intended to be illustrative only, and are not to be deemed to limit the scope of the invention. To the contrary, it will be apparent to those of ordinary skill in the art that many changes, additions and/or deletions may be made to the disclosed embodiments without departing from the scope and spirit of the invention.

What is claimed is:

1. A satellite broadcasting system, comprising:
a transmitter including transmitting means for transmitting data signals on first and second communication channels via satellite; and
a receiver including
receiving means for receiving the data signals on the first and second communication channels, and
tuning means responsive to a selected communication channel indication for tuning in a particular one of the first and second communication channels identified by the selected communication channel indication;
wherein the transmitter transmits to the receiver on the particular communication channel based on the selected communication channel indication.

2. The satellite broadcasting system of claim 1, wherein the receiver further includes:
selecting means coupled with the receiving means for selecting one of the first and second communication channels and developing a selected communication channel indication; and
communicating means for communicating the selected communication channel indication to the transmitter.

3. The satellite broadcasting system of claim 2, wherein each of the first and second communication channels has a load level, and wherein the selecting means selects a selected communication channel according to which communication channel has the lowest load level.

4. The satellite broadcasting system of claim 3, wherein the communicating means provides the transmitter with a selected communication channel indication via a dial-in connection to the transmitter.

5. The satellite broadcasting system of claim 4, wherein the transmitter is responsive to the indication and thereby transmits to the receiver on the selected communication channel.

6. The satellite broadcasting system of claim 2, wherein the first communication channel has a first bit rate and the second communication channel has a second bit rate greater than the first bit rate, and wherein signals received by the receiver are characterized at any given time by an energy-per-bit to noise ratio, and wherein the receiver further includes means for monitoring the energy-per-bit to noise ratio.

7. The satellite broadcasting system of claim 6, wherein if the receiver is tuned to the second communication channel, the selecting means selects the first communication channel if the energy-per-bit to noise ratio of the receiver falls below a is predetermined shift-low threshold.

8. The satellite broadcasting system of claim 6, wherein each communication channel has a load factor, and wherein if the receiver is tuned to the first communication channel, the selecting means selects the second communication channel if the energy-per-bit to noise ratio of the receiver rises above a predetermined shift-high threshold and the load factor of the second communication channel is less than the load factor of the first communication channel.

9. The satellite broadcasting system of claim 2, wherein the first communication channel has a first power level and the second communication channel has a second power level lower than the first power level, and wherein signals received by the receiver are characterized at any given time by an energy-per-bit to noise ratio, and wherein the receiver further includes means for monitoring the energy-per-bit to noise ratio.

10. The satellite broadcasting system of claim 9, wherein if the receiver is tuned to the second communication channel, the selecting means selects the first communication channel if the energy-per-bit to noise ratio of the receiver falls below a first predetermined threshold.

11. The satellite broadcasting system of claim 9, wherein each communication channel has a load factor, and wherein if the receiver is tuned to the first communication channel, the selecting means selects the second communication channel if the energy-per-bit to noise ratio of the receiver rises above a second predetermined threshold and the load factor of the second communication channel is less than the load factor of the first communication channel.

12. The satellite broadcasting system of claim 1, wherein the transmitter further includes:
selecting means coupled with the transmitting means for selecting one of the first and second communication channels for communication with the receiver and developing a selected communication channel indication; and
notifying means responsive to the selecting means for providing the receiver with the selected communication channel indication.

13. The satellite broadcasting system of claim 12, wherein each of the first and second communication channels has a load level, and wherein a selected communication channel is selected by the selecting means according to which communication channel has the lowest load level.

14. The satellite broadcasting system of claim 13, wherein the notifying means provides the receiver with an indication of the selected communication channel via the particular communication channel.

15. The satellite broadcasting system of claim 14, wherein the tuning means of the receiver is responsive to the indication and thereby tunes in to the selected communication channel.

16. The satellite broadcasting system of claim 12, wherein the first communication channel has a first bit rate and the second communication channel has a second bit rate greater than the first bit rate, and wherein signals received by the receiver are characterized at any given time by an energy-per-bit to noise ratio, and wherein the receiver further includes means for monitoring the energy-per-bit to noise ratio, and wherein the receiver periodically communicates the energy-per-bit to noise ratio to the transmitter.

17. The satellite broadcasting system of claim 16, wherein if the receiver is tuned to the second communication channel, the selecting means selects is the first communication channel if the energy-per-bit to noise ratio of the receiver falls below a predetermined shift-low threshold.

18. The satellite broadcasting system of claim 16, wherein each communication channel has a load factor, and wherein if the receiver is tuned to the first communication channel, the selecting means selects the second communication channel if the energy-per-bit to noise ratio of the receiver rises above a predetermined shift-high threshold and the load factor of the second communication channel is less than the load factor of the first communication channel.

19. The satellite broadcasting system of claim 12, wherein the first communication channel has a first power level and the second communication channel has a second power level lower than the first power level, and wherein signals received by the receiver are characterized at any given time by an energy-per-bit to noise ratio, and wherein the receiver further includes means for monitoring the energy-per-bit to noise ratio, and wherein the receiver periodically communicates the energy-per-bit to noise ratio to the transmitter.

20. The satellite broadcasting system of claim 19, wherein if the receiver is tuned to the second communication channel, the selecting means selects the first communication channel if the energy-per-bit to noise ratio of the receiver falls below a first predetermined shift threshold.

21. The satellite broadcasting system of claim 19, wherein each communication channel has a load factor, and wherein if the receiver is tuned to the first communication channels the selecting means selects the second communication channel if the energy-per-bit to noise ratio of the receiver rises above a predetermined shift-low threshold and the load factor of the second communication channel is less than the load factor of the first communication channel.

22. The satellite broadcasting system of claim 1, wherein the transmitter transmits digital data signals at a first bit rate on the first communication channel and transmits digital data signals at a second bit rate different from the first bit rate on the second communication channel.

23. The satellite broadcasting system of claim 22, wherein the first bit rate is greater than the second bit rate.

24. The satellite broadcasting system of claim 1, wherein the transmitter transmits digital data signals at a first power level on the first communication channel and transmits digital data signals at a second power level different from the first power level on the second communication channel.

25. The satellite broadcasting system of claim 24, wherein the first power level is greater than the second power level.

26. The satellite broadcasting system of claim 1, wherein the transmitter transmits digital data signals at equal bit rates on the first and second communication channels.

27. The satellite broadcasting system of claim 1, wherein the first and second communication channels comprise signals broadcast by a single satellite transponder at different frequencies.

28. The satellite broadcasting system of claim 1, wherein the first and second communication channels comprise respective first and second signals broadcast by at least one satellite at a single frequency, and wherein one of the first and second signals has a different polarization than the other.

29. The satellite broadcasting system of claim 28, wherein one of the first and second signals is left-hand circularly polarized and the other signal is right-hand circularly polarized.

30. The satellite broadcasting system of claim 1, wherein the first and second communication channels comprise signals broadcast by a plurality of satellite transponders.

31. The satellite broadcasting system of claim 1, wherein the first and second communication channels comprise signals broadcast by a single satellite.

32. The satellite broadcasting system of claim 1, wherein the transmitter transmits to the receiver on one of a plurality of communication channels, said plurality including the first and second communication channels.

33. The satellite broadcasting system of claim 32, wherein the transmitter includes means for determining a communication channel load factor for each of the plurality of communication channels.

34. The satellite broadcasting system of claim 33, wherein the transmitter transmits to the receiver on a particular one of the communication channels based on the communication channel load factors.

35. The satellite broadcasting system of claim 33, wherein the transmitter transmits to the receiver on a channel selected in an effort substantially uniformly allocate communication among the communication channels.

36. The satellite broadcasting system of claim 33, wherein the first communication channel comprises a first digital signal having a first bit rate and a first communication channel load level and the second communication channel comprises a second digital signal having a second bit rate greater than the first bit rate and a second communication channel load level.

37. The satellite broadcasting system of claim 36, wherein the communication channel load factor of the first communication channel exceeds the first communication channel load level and the communication channel load factor of the second communication channel substantially equals the second communication channel load level.

38. The satellite broadcasting system of claim 37, wherein the communication channel load factor of the first communication channel exceeds the first communication channel load level by about twenty five percent.

39. The satellite broadcasting system of claim 1, wherein the transmitter broadcasts information pertaining to each communication channel.

40. The satellite broadcasting system of claim 39, wherein each communication channel is characterized by a frequency, a bit rate, a power level, and a load factor, and wherein the information pertaining to each communication channel comprises the communication channel's frequency, bit rate, power level, or load factor.

41. A satellite broadcasting system, comprising:
a transmitter including transmitting means for transmitting data signals on first and second communication channels via satellite; and
a computer terminal including
receiving means for receiving the data signals on the first and second communication channels, and
tuning means responsive to -a selected communication channel indication for tuning in a particular one of the first and second communication channels identified by the selected communication channel indication;
wherein the transmitter transmits to the computer terminal on the particular communication is channel based on the selected communication channel indication.
